(19) United States
(12) Patent Application Publication
(10) Pub. No.: US 2026/0320210 A1
(43) Pub. Date: Oct. 15, 2026

(54) MACHINE-LEARNED MODEL BASED COMPLIANCE SYSTEM

(71) Applicant: Charter Communications Operating, LLC, St. Louis, MO (US)

(72) Inventors: Steven Michael Koch, II, Cedar Hill, MO (US); Michael Sean Green, St. Charles, MO (US)

(21) Appl. No.: 19/174,005

(22) Filed: Apr. 9, 2025

(51) Int. Cl. G06F 21/62; G06Q 50/18

(52) U.S. Cl. CPC G06F 21/6218; G06Q 50/18

(57) ABSTRACT

A first set of MLMs processes an input indicative of a unit of software instructions to obtain a security compliance output indicating the unit of software instructions fails to comply with a set of security compliance policies. The security compliance output can include a plurality of proposed modifications to the unit of software instructions. A second set of MLMs evaluates the input and the security compliance to generate a validated information output that validates one or more proposed modifications of the plurality of proposed modifications to the unit of software instructions comply with the set of security compliance policies. Based on the validated information output, a third set of MLMs process the security compliance output and the set of historical information, including a prior output of the third set of MLMs, to obtain an output including a modified unit of software instructions that incorporates the one or more proposed modifications.

### BACKGROUND

Developing software requires compliance with both external policies and internal policies related to the development of the software. Generally, developers must refer to a variety of information during the software development lifecycle, such as policies related to system security, company policies, and governmental regulations.

### SUMMARY

The embodiments disclosed herein provide for a machine-learned model based compliance system. In particular, the embodiments provide for obtaining an output based on an input processed by a plurality of machine-learned models (MLMs).

In one implementation, a method is provided. The method includes processing, by a computing system comprising one or more processor devices, an input indicative of a unit of software instructions with a first set of MLMs to obtain a security compliance output indicating that the unit of software instructions fails to comply with a set of security compliance policies, wherein the security compliance output comprises a plurality of proposed modifications to the unit of software instructions. The method further includes evaluating, by the computing system, the input indicative of the unit of software instructions and the security compliance output with a second set of MLMs to generate a validated information output, wherein the validated information output validates one or more proposed modifications of the plurality of proposed modifications to the unit of software instructions comply with the set of security compliance policies. The method further includes, based on the validated information output, processing, by the computing system, the security compliance output and a set of historical information with a third set of MLMs to obtain an output comprising a modified unit of software instructions that incorporates the one or more proposed modifications, wherein the set of historical information comprises a prior output of the third set of MLMs.

In another implementation, a computing system is provided. The computing system includes a processor and one or more non-transitory, computer-readable media that store instructions that, when executed by the processor, cause the computing system to perform operations. The operations include processing an input indicative of a unit of software instructions with a first set of MLMs to obtain a security compliance output indicating that the unit of software instructions fails to comply with a set of security compliance policies, wherein the security compliance output comprises a plurality of proposed modifications to the unit of software instructions. The operations further include evaluating the input indicative of the unit of software instructions and the security compliance output with a second set of MLMs to generate a validated information output, wherein the validated information output validates one or more proposed modifications of the plurality of proposed modifications to the unit of software instructions comply with the set of security compliance policies. The operations further include, based on the validated information output, processing the security compliance output and a set of historical information with a third set of MLMs to obtain an output comprising the proposed modification to the unit of software instructions, wherein the set of historical information comprises a prior input and a corresponding prior output, and wherein the third set of MLMs are operable to select the proposed modification to the unit of software instructions from a plurality of candidate modifications to the unit of software instructions.

In another implementation, one or more non-transitory computer-readable storage media are provided. The one or more non-transitory computer-readable storage media include executable instructions that cause a processor device to process an input indicative of a unit of software instructions with a first set of MLMs to obtain a security compliance output indicating that the unit of software instructions fails to comply with a set of security compliance policies, wherein the security compliance output comprises a plurality of proposed modifications to the unit of software instructions. The instructions further cause the processor device to evaluate the input indicative of the unit of software instructions and the security compliance output with a second set of MLMs to generate a validated information output, wherein the validated information output validates one or more proposed modifications of the plurality of proposed modifications to the unit of software instructions comply with the set of security compliance policies. The instructions further cause the processor device to, based on the validated information output, process the security compliance output and a set of historical information with a third set of MLMs to obtain an output comprising a modified unit of software instructions that incorporates the one or more proposed modifications, wherein the set of historical information comprises a prior output of the third set of MLMs.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment for a machine-learned model based compliance system according to some implementations of the present disclosure.

FIG. 2 is a block diagram of a plurality of machine-learned models for a machine-learned model based compliance system according to some implementations of the present disclosure.

FIG. 3 is a sequence flow diagram for a machine-learned model based compliance system according to some implementations of the present disclosure.

FIG. 4 is a flowchart diagram for a method of a machine-learned model based compliance system according to some implementations of the present disclosure.

FIG. 5 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Software development requires consideration of a vast number of restrictions and requirements defining compliance rules for the software during the development of the software. Laws, administrative rules, security policies, company policies, among others, all play an important role in developing compliant software. To become aware of relevant and specific policies, developers either refer to such materials themselves or seek the assistance of another person in researching the restrictions and requirements for them.

Software developers are not all subject to the same compliance rules, and the aggregation of compliance rules for developing a particular software can be time-consuming and expensive. Some of the compliance rules aggregated may not even be relevant to the developer, resulting in wasted time and resources, and in some instances, implementation of irrelevant compliance rules into codebases. For example, if a developer or another person assisting the developer spends a significant amount of time and resources searching for all compliance rules that may apply to the software being developed, time and resources risk being wasted in collecting compliance rules that are irrelevant. The delay in time caused by gathering the compliance rules also results in time away from developing the software, thus prolonging development.

Accordingly, implementations described herein propose a machine-learned model (MLM) based compliance system. For example, assume that a computing system, such as a network computing system or a distributed network of computing devices, receives an input indicative of a unit of software instructions. The computing system can use a first set of MLMs to process the input indicative of the unit of software instructions. In processing the query, the computing system uses a first set of MLMs of the plurality of MLMs to generate information related to the input based on an evaluated set of security compliance policies. Examples of compliance policies can include company policies, laws (including regulatory standards), administrative rules, security standards, development policies, and the like.

More specifically, in some instances, each MLM of the first set of MLMs can be assigned a “role” corresponding to a particular type of subject matter expert. Each of the MLMs can then evaluate whether the unit of software instructions complies with a particular type of policy (e.g., a security role can evaluate whether the unit of software instructions complies with a set of security policies, a development role can evaluate whether the unit of software instructions complies with a set of development practices, etc.). If an MLM determines that the unit of software instructions does not comply with a particular set of policies, the MLM can generate an output that suggests a proposed modification to “mitigate” the compliance failure. As such, in some instances, multiple MLMs of the first set of MLMs can determine that the unit of software instructions fails to comply with multiple sets of policies, and can further generate multiple proposed modifications to mitigate such compliance failures.

For example, assume that one MLM of the first set of MLMs evaluates whether software instructions comply with internal company-mandated cybersecurity policies, while another of the first set of MLMs evaluates whether software instructions comply with a set of government regulations associated with certain types of software (e.g., autonomous vehicles, flight systems, etc.). If the company-mandated cybersecurity policies mandate that recursion is not used in a codebase, and the unit of software instructions utilizes recursion, the security MLM may output a proposed modification that removes recursion from the software instructions while maintaining functionality. Additionally, if the set of government regulations mandate that each function includes a redundancy, and the unit of software instructions does not include a redundancy, the regulatory MLM may output a proposed modification that adds redundancy to the software instructions while maintaining functionality.

Further, in some implementations, such role-specific MLMs can access role-specific databases to retrieve relevant policies, regulations, etc. To follow the previous example, an MLM that evaluates whether the unit of software instructions complies with certain governmental regulations may access a database (e.g., via Retrieval Augmented Generation (RAG), etc.) populated with up-to-date regulations, interpretations of said regulations, legal works related to the regulations, and other contextual information. The computing system can evaluate the information related to the input using a second set of MLMs by having the second set of MLMs receive the information related to the input from the first set of MLMs via the message bus, and then process the information related to the input to validate the information. Like the first set of MLMs, each of the second set of MLMs can be assigned particular roles to validate the information. For example, assume that the information output by the first set of MLMs indicates that the unit of software instructions fails to comply with a certain security policy. Further assume that the output includes a proposed modification to the unit of software instructions to mitigate the compliance failure. The second set of MLMs can evaluate the security compliance output generated by the first set of MLMs to generate a validation output. The validation output can validate at least some of the plurality of proposed modifications to the unit of software instructions in the security compliance output complies with a set of security compliance policies, or otherwise “fixes” or mitigates the compliance failure identified previously.

Once validated, the computing system can process the information related to the input that was generated by the first set of MLMs alongside historical information that is descriptive of a prior output using a third set of MLMs. The output can include a modified unit of software instructions that incorporates the one or more proposed modifications. To follow the previous example, assume that the second set of MLMs validates the proposed modification that removes recursion from the software instructions, but fails to validate the proposed modification that adds redundancy to the software instructions. The third set of MLMs can apply the proposed modification that removes recursion to the unit of software instructions to obtain the modified unit of software instructions.

Aspects of the present disclosure provide a number of technical effects and benefits. As one example of a technical effect and benefit, inaccurate or irrelevant compliance rules obtained by the developer or other persons manually can have severe ramifications for the software developers and their user-base, such as in a security breach due to insufficient security policies being implemented or inconsistencies internal to the developer if not following company policies in developing the software, risking future inefficiency when updating the software or incompatibility with future applications. Existing compliance methods involve manually searching for the compliance rules pertaining to the software being developed. However, manually searching for all potentially relevant compliance rules can be expensive, time consuming, and unreliable for the aforementioned reasons. Accordingly, implementations of the present disclosure can autonomously and intelligently process a query associated with compliance in software development environments to provide an output descriptive of guidance and best practices based on a set of compliance rules accessed by a plurality of MLMs and historical information descriptive of a prior query received from the user and a corresponding output provided to the user. The implementation of MLMs provide for autonomous and instantaneous aggregation of all relevant compliance rules. By substantially reducing the quantity of time required to aggregate information and ensuring relevant information is obtained based on historical context, implementations of the present disclosure obviate the inefficiencies associated with manually search and aggregation of software compliance rules.

Another example of a technical benefit and affect is the altering of software instructions to be compliant with existing standards and/or regulations. The automation of compliance checking, modification generation, and modification selection minimize the risk of error in implementing specific compliance policies in software development.

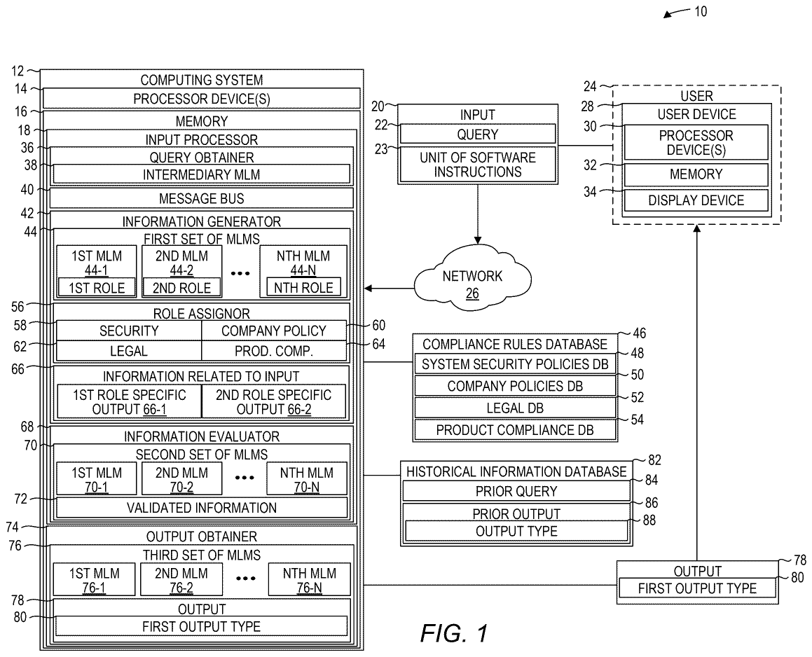

FIG. 1 is a block diagram of a computing environment 10 for a machine-learned model-based compliance system according to some implementations of the present disclosure. The computing environment 10 can be any type or manner of computing environment implemented by one or more entities, such as a cloud platform, on-site infrastructure, or one or more edge devices. The computing environment 10 can include any type of manner of computing device, network device, network infrastructure, and the like. For example, the computing environment 10 can be a desktop computer used by a software developer.

The computing environment 10 can include a computing system 12. The computing system 12 can include processor device(s) 14 and memory 16. In some implementations, the computing system 12 may be a computing system that includes multiple computing devices. Alternatively, in some implementations, the computing system 12 may be one or more computing devices within a computing environment that includes multiple distributed devices and/or systems. Similarly, the processor device(s) 14 may include any computing or electronic device capable of executing software instructions to implement the functionality described herein. For example, the processor device(s) 14 can include a general-purpose processor.

The memory 16 can include an input processor 18. The input processor 18 can perform various operations to process a query. In particular, the input processor 18 of the computing system 12 can process an input 20 indicative of a query 22 received from a user 24. The input 20 can include a plurality of textual portions, such as natural language, code snippets, pre-filled commands, and the like. In some implementations, the plurality of textual portions are a combination of natural language, code snippets, pre-filled commands, and the like.

For example, the input 20 can include a request for guidance on how best to implement specific compliance rules within the software being developed (i.e. the query 22) and a unit of software instructions 23 associated with the software. The unit of software instructions 23 can include machine-executable software instructions such as some or all portions of application software and/or system software. In some implementations, the unit of software instructions 23 can be one part of an entirety of software instructions (i.e., a “codebase” for an application, etc.). In some implementations, the unit of software instructions 23 can be the entirety of the software instructions for the software.

The input 20 includes, either explicitly or implicitly, the query 22 for the computing system 12. For example, the query 22 can be explicit in the input 20 by way of one or more pre-filled commands requesting the computing device 12 to provide a specific output. As another example, the query 22 can be implicit in the input 20 by way of one or more sets of natural language within the input 20, such as an inquiry as how to best conform to system security policies during software development or an inquiry as to whether the unit of software instructions 23 provided in the input 20 conforms to existing system security policies.

In some implementations, the computing system 12 receives the input 20 via a network 26 from a user device 28. The network 26 can be any type or manner of network permitting communication between two or more devices, including Wi-Fi, ethernet, LAN, and the like. The user device 28 can include processor device(s) 30 and memory 32 as described with regards to the processor device(s) 14 and the memory 16 of the computing system 12. The user device 28 can also include a display device 34 for the user 24 to enter the input 20 for the computing system 12. In some implementations, the computing system 12 can receive the input 20 from the user device 28. For example, the computing system 12 can obtain the input 20 via an Application Programming Interface (API), direct database connections, direct transfer of files in proprietary file formats, as a structured data object, and the like. In some implementations, the user 24 inputs the input 20 using the computing system 12 itself, such as, for example, by use of peripherals attached to the computing system 12 to input the input 20.

The input processor 18 can include a query obtainer 36. The query obtainer 36 can obtain the query 22 from the input 20. In some implementations, the query obtainer 36 analyzes the plurality of textual portions of the input 20 to determine which textual portions of the plurality of textual portions are indicative of the query 22. In some implementations, the query obtainer 36 can include an intermediary MLM 38 to analyze the plurality of textual portions of the input 20. For example, computing system 12 can receive the input 20. The intermediary MLM 38 analyzes the plurality of textual portions of the input 20 to obtain the query 22. Following this example, the intermediary MLM 38 determines that a textual portion of the plurality of textual portions includes natural language. The intermediary MLM 38 determines that the natural language is directed to an inquiry as to whether the unit of software instructions 23 provided in the input 20 complies with existing system security policies. The intermediary MLM 38 extracts the query 22 from the input 20. In some implementations, the intermediary MLM 38 can encode the query 22 to obtain an encoded version of the query 22.

In some implementations, the computing system 12 includes a message bus 40. The intermediary MLM 38 can transmit the query 22 and/or the encoded version of the query 22 to each other MLM in a plurality of MLMs in the computing system 12 via the message bus 40. In some implementations, the plurality of MLMs can send and receive communications related to the query 22 to one another via the message bus 40. In some implementations, the message bus 40 is implemented using a Publish-Subscribe method, wherein each of the plurality of MLMs, including the intermediary MLM 38, are subscribed to one another and receive real-time communication from all other MLMs. In some implementations, the message bus 40 is implemented using an Event-Driven method. One skilled in the art will appreciate that any known or existing method of implementing the message bus 40 to enable the plurality of MLMs to perform inter-modal communication would be effective to implement the implementations disclosed herein.

In some implementations, the input processor 18 includes an information generator 42. The information generator 42 generates information based on the input 20 using a set of compliance rules. The information generator 42 can include a first set of MLMs 44 of the plurality of MLMs, including first MLM 44-1 having a first role, second MLM 44-2 having a second role, and NTH MLM 44-N having an nth role. There is no limit as to the number of MLMs that can be included in the first set of MLMs 44. The first set of MLMs 44 can receive the input 20 from the intermediary MLM 38 via the message bus 40. Each MLM is the first set of MLMs 44 analyzes the input 20 by evaluating the set of compliance rules in a compliance rules database 46. The compliance rules database 46 can include a plurality of databases directed to various policies.

In some implementations, the compliance rules database 46 can include a system security policies database 48. The system security policies database 48 can include any information related to policies dictating sufficient security measures to be implemented in, for example, software. System security policies can include restrictions against application programming interface (API) calls to external services not yet validated. System security policies can further include secure coding policies from the General Data Protection Regulation (GDPR), the California Consumer Privacy Act (CCPA), and the like. System security policies can further include user tracking to avoid unnecessary reauthentication, the implementation of multiple software integrity strategies, and data sanitization after a predetermined period of time.

In some implementations, the compliance rules database 46 further includes a company policies database 50. The company policies database 50 can include internal policies related to a company that is currently developing, for example, software. Examples of company policies include format requirements, stylistic preferences, and the like.

In some implementations, the compliance rules database 46 further includes a legal database 52. The legal database 52 can include a plurality of laws related governing, for example, software development. Examples of laws include privacy laws within the GDPR and CCPA, as well as any other laws relevant to software development.

In some implementations, the compliance rules database 46 further includes a product compliance database 54. The product compliance database 54 can include safety and ethical standards for, by way of example, software.

In some implementations, some or all of the databases in the compliance rules database 46 include internet-based resources. For example, an MLM of the first set of MLMs 44 accessing the system security policies database 48 can have access to the internet to search for system security policies not explicitly within the system security policies database 48.

In some implementations, each of the MLMs in the first set of MLMs 44 evaluates a database in the compliance rules database based on a role assigned to each respective MLM in the first set of MLMs 44. For example, if the first role of the first MLM 44-1 is related to system security, the first MLM 44-1 will only evaluate the system security policies database 48 against the input 20. In some implementations, the roles given to each MLM in the first set of MLMs 44 are different from one another, such that each MLM evaluates a respective database in the compliance rules database 46. For example, if the first MLM 44-1 has the first role being related to system security, then the second MLM 44-2 can have the second role be related to company policies, such that the second MLM 44-2 can evaluate the company policies database 50 against the input 20 while the first MLM 44-1 evaluates the system security policies database 48. In some implementations, each MLM in the first set of MLMs 44 evaluates the set of compliance rules simultaneously. In some implementations, evaluation is performed sequentially.

In some implementations, the information generator 42 includes a role assignor 56. The role assignor 56 assigns a role to each MLM in the first set of MLMs 44. The role assignor 56 can include roles associated with the databases in the compliance rules database 46. In some implementations, each MLM in the first set of MLMs 44 is restricted to accessing only the databases in the compliance rules database 46 for which they have a respective assigned role. For example, the role assignor can include a security role 58 associated with the system security policies database 48, a company policy role 60 associated with the company policies database 50, a legal role 62 associated with the legal database 52, and a product compliance role 64 associated with he product compliance database 54. Following this example, the role assignor 56 can assign the security role 58 to the first MLM 44-1. Since the first MLM 44-1 has been assigned the security role 58, the first MLM 44-1 can access the system security policies database 48, but no other database in the compliance rules database 46. In some implementations, the role assignor 56 assigns only one role to each of the MLMs in the first set of MLMs 44. In some implementations, the role assignor 56 can assign more than one role to one or more MLMs in the first set of MLMs 44. For example, the role assignor 56 can assign both the security role 58 and the legal role 52 to the first MLM 44-1 so that the first MLM 44-1 can access both the system security policies database 48 and the legal database 52.

In some implementations, the role assignor 56 assigns different roles to the first set of MLMs 44 so that each MLM in the first set of MLMs 44 has exclusive access to a respective database in the compliance rules database 46. For example, the role assignor 56 can assign the security role 58 to the first MLM 44-1 and the company policy role 60 to the second MLM 44-2. As a result, the first MLM 44-1 will have access to the system security policies database 48 and the second MLM 44-2 will have access to the company policies database 50. In this example, each MLM in the first set of MLMs 44 can individually evaluate their respectively assigned policies in the compliance rules database 46 according to their assigned role to generate the information related to the input 66 based on the individual evaluations.

In some implementations, the role assignor 56 assigns roles to the first set of MLMs 44 based partially or wholly on the query 22. By way of example, if the query 22 is related to system security compliance, then the role assignor 56 will assign the first MLM 44-1 the security role 58. In some implementations, the role assignor 56 only assigns roles to the first set of MLMs 44 according to the query 22. For example, if the query 22 is related only to system security and company policy compliance by way of the user requesting within the input 20 guidance on whether the unit of software instructions 23 provided in the input 20 adheres to system security policies, then the role assignor 56 assigns the security role 58 to the first MLM 44-1 and will not assign any other roles to any of the remaining first set of MLMs 44. In relying on the query 22, the role assignor 56 allows only a limited number of the first set of MLMs 44 to process the unit of software instructions 23, thus reducing unnecessary computing resource usage. In some implementations, the role assignor 56 will assign all available roles to the first set of MLMs 44 without consideration of the query 22.

Each of the MLMs in the first set of MLMs 44 can evaluate the set of compliance rules in the compliance rules database 46 according to the role assigned to each MLM in the first set of MLMs 44 to generate the information related to the input 66. In some implementations, the information related to the input 66 can include role specific outputs associated with each MLM in the first set of MLMs 44 that evaluates the set of compliance rules according to their assigned role. For example, the first MLM 44-1 can generate a first role specific output 66-1 based on the first role associated with the first MLM 44-1. If the first MLM 44-1 is assigned the security role 58, the first MLM 44-1 can generate the first role specific output 66-1 based on evaluation of the input 20 against system security policies in the system security policies database 48. Similarly, if the second MLM 44-2 is assigned the company policy role 60, the second MLM 44-2 can generate a second role specific output 66-2 based on evaluation of the input 20 against company policies in the company policies database 50. In some implementations, the first role specific output 66-1 and the second role specific output 66-2 each have a unique identifier. The unique identifier identifies the MLM that generated the role specific output and the role associated with the respective MLM.

As an illustrative example, the role assignor 56 assigns the first MLM 44-1 the security role 58. The first MLM 44-1 as a result can evaluate the input 20 against the system security policies database 48. The first MLM 44-1 can then generate the first role specific output 66-1. In this example, the first role specific output 66-1 can include a security compliance output. The security compliance output can indicate that the unit of software instructions 23 provided in the input 20 fails to comply with the set of security compliance policies in the system security policies database 48. The security compliance output can also include a plurality of proposed modifications to the unit of software instructions 23. The plurality of proposed modifications to the unit of software instructions 23 can include modifications to at least some or all of the unit of software instructions 23. For example, the first MLM 44-1 can determine that the unit of software instructions 23 fails to comply with the set of security compliance policies due to a lack of a data sanitization function within the unit of software instructions 23. As a result, the security compliance output can indicate the compliance failure, and include a proposed modification to the unit of software instructions including the data sanitization function within the unit of software instructions 23. In some implementations, the proposed modification can be one or more rewritten portions of the unit of software instructions 23 or the unit of software instructions 23 rewritten in its entirety, separated in chunks by functions, variables, and the like. In some implementations, the first MLM 44-1 can generate proposed modifications in the first role specific output 66-1 via accessing a set of templates in the system security policies database 48 associated with the related system security policy or policies that the unit of software instructions 23 should adopt to comply with the system security policies. The template can be included in an unmodified form in the first role specific output 66-1 either alongside or separate from the proposed modification generated using the template. For example, if the unit of software instructions 23 requires a data sanitization feature to comply, the first role specific output 66-1 can include an in-lined function to the unit of software instructions 23 that includes the data sanitization function, and can include the template used to create the in-lined function.

In some implementations, the first role specific output 66-1 includes a recommendation including the proposed modification. The first role specific output 66-1 can have the security compliance output include a natural language recommendation including the proposed modification that would result in the unit of software instructions 23 being compliant with the system security policies in the system security policies database 48. For example, if the unit of software instructions 23 requires a data sanitization feature to comply, the proposed modification in the first role specific output 66-1 can include a natural language generated textual portion recommending that the user include a data sanitization feature to the unit of software instructions 23. For another example, the proposed modification in the first role specific output 66-1 can include proposed changes to the unit of software instructions to add the data sanitization feature.

In some implementations, the first role specific output 66-1 generated by the first MLM 44-1 includes an information query for the second MLM 66-2 sent via the message bus 40. For example, during evaluation of the system security policies database 48, first MLM 44-1 having the security role 58 can send the information query to the second MLM 44-2 having the company policy role 60. The information query can include a request as to whether certain system security policies in the system security policies database 48 are compatible with compliance rules in the company policies database 50. The information query can include system security policies at issue from the system security policies database 48 sought for compatibility evaluation by the second MLM 44-2. The second MLM 44-2 evaluates the compliance rules in the company policies database 50 against the information query and generates an associated response (i.e. the second role specific output 66-2). The associated response is sent from the second MLM 44-2 to the first MLM 44-1 via the message bus 40. The associated response can include a determination as to whether the provided system security policies from the system security policies database 48 are compatible with the compliance rules in the company policies database 50. For example, the associated response can include a determination that one or more of the provided system security policies are not compatible with one or more compliance rules in the company policies database 50. Based on the determination, the first MLM 44-1 can regenerate the first role specific output 66-1 to include an evaluation of the compliance rules in the system security policies database 48 based on the associated response sent by the second MLM 44-2.

For a specific example, assume that the MLM 44-1 of the first set of MLMs is assigned a security role and the MLM 44-2 of the first set of MLMs is assigned a company policy role. The MLM 44-1 can access the system security policies database 48 to obtain security policies relevant to the unit of software instructions 43. For example, the MLM 44-1 may process the unit of software instructions 23 with an embedding model to obtain an embedding, and then use the embedding to perform a similarity search to retrieve relevant policies from the system security policies database 48 (e.g., to implement Retrieval Augmented Generation (RAG), etc.). The MLM 44-1 can then process the unit of software instructions 23 and the relevant security policies to evaluate whether the unit of software instructions 23 complies with the relevant security policies. If the unit of software instructions 23 fails to comply with any of the relevant security policies, the MLM 44-1 can generate a proposed modification to the unit of software instructions 23 that remedies the compliance failure. The MLM 44-2 can perform the same operations with regards to the company policies database 50. In such fashion, multiple MLMs from the first set of MLMs 44 can be used to generate multiple proposed modifications to the unit of software instructions 23.

The input processor 18 can include an information evaluator 68. The information evaluator 68 evaluates the information related to the input 66 generated by the first set of MLMs 44. It should be noted that the information related to the input 66 may also be referred to interchangeably herein as output(s) of the first set of MLMs 44. In some implementations, the information evaluator 68 includes a second set of MLMs 70 of the plurality of MLMs, including a first MLM 70-1, a second MLM 70-2, and NTH MLM 70-N. There is no limit as to the number of MLMs that can be included in the second set of MLMs 70. The second set of MLMs 70 can receive the information related to the input 66 from the first set of MLMs 44 via the message bus 40 for evaluation of the information related to the input 66.

In some implementations, the second set of MLMs 70 can evaluate the information related to the input 66 by verifying the information related to the input 66 to ensure the accuracy of the information generated by the first set of MLMs 44. For example, the first MLM 70-1 can receive the information related to the input 66 via the message bus 40, the information related to the input 66 including the first role specific output 66-1 and the second role specific output 66-2. The first MLM 70-1 determines which MLMs in the first set of MLMs 44 generated the first role specific output 66-1 and the second role specific output 66-2, respectively. In some implementations, the first MLM 70-1 sends a general inquiry to the first set of MLMs 44 via the message bus. The general inquiry can include a request for identification of the MLMs that generated the respective role specific outputs. The first MLM 70-1 can then receive identification from the first set of MLMs 44 that, for example, the first MLM 44-1 generated the first role specific output 66-1 and the second MLM 44-2 generated the second role specific output 66-2.

In some implementations, the first MLM 70-1 analyzes the first role specific output 66-1 and the second role specific output 66-2 to identify the unique identifiers. For example, the first MLM 70-1 can analyze the first role specific output 66-1 to determine that the unique identifier identifies the first MLM 44-1 as having generated the first role specific output 66-1.

Once the first MLM 70-1 has determined which MLM in the first set of MLMs 44 generated the role specific outputs, the first MLM 70-1 can then verify the accuracy of the information in the role specific outputs. In some implementations, the first MLM 70-1 sends a request via the message bus 40 to the first MLM 44-1 to verify the information in the first role specific output 66-1. In response, the first MLM 44-1 accesses the related database to compare the first role specific output 66-1 to the compliance rules in the related database to verify the accuracy of the role specific output 66-1. If the first MLM 44-1 finds a discrepancy between the policies in the related database and the first role specific output 66-1, the first MLM 44-1 can then regenerate the first role specific output 66-1 to reflect the updated and accurate information and send the first role specific output 66-1 back to the first MLM 70-1. If the first MLM 44-1 does not find a discrepancy, the first MLM 44-1 can send an accuracy verification indicator to the first MLM 70-1 via the message bus. The accuracy verification indicator can be, for example, a natural language message confirming the accuracy of the first role specific output 66-1.

In some implementations, the first MLM 70-1 independently accesses the database related to the first role specific output 66-1 to verify the accuracy of the role specific output 66-1 independently from the first MLM 44-1. For example, if the first role specific output 66-1 was generated by the first MLM 44-1 having the security role 58, the first MLM 70-1 accesses the system security policies database 48 independently. The first MLM 70-1 then compares the first role specific output 66-1 against the system security policies database 48 to verify that the proposed modification to the unit of software instructions 23 complies with the system security policies database 48. The first MLM 70-1 independently accessing the related database acts as an alternative viewpoint with respect to the proposed modification to the unit of software instructions 23 to ensure the accuracy and integrity of the unit of software instructions 23.

Specifically, the second set of MLMs 70 can perform validation operations (e.g., conflict resolution, validation, optimization, etc.) to validate some (or all) of the proposed modifications to the unit of software instructions 23. For example, assume that the first role specific output 66-1 includes a proposed modification to remove a recursive function from the unit of software instructions 23. Further assume that the role-specific output 66-2 includes a proposed modification to add a data smoothing function that relies on the recursive function to operate. Here, the second set of MLMs 70 may determine to validate the first modification and invalidate the second modification, as both modifications cannot be applied. Additionally, in some instances, the second set of MLMs 70 may determine that the first modification should be validated rather than the second modification due to a perceived degree of importance associated with the first modification (e.g., due to the first modification being related to security). As such, the set of second MLMs 70 can make validation decisions in a manner that optimizes which of the role specific outputs 66 are validated.

In some implementations, where the first MLM 70-1 independently verifies the first role specific output 66-1, the first MLM 70-1 can determine that there is a discrepancy between a proposed modification to the unit of software instructions in the plurality of proposed modifications in the first role specific output 66-1 and the related database. As a result, the first MLM 70-1 determines that the proposed modification to the unit of software instructions is invalid. Following the previous example, the first MLM 70-1 can determine that one or more of the proposed modifications to the unit of software instructions 23 in the information in the first role specific output 66-1, such as the proposed modification to the unit of software instructions 23, is inconsistent with system security policies in the system security policies database 48. When the first MLM 70-1 determines there is a discrepancy, the first MLM 70-1 can send a communication related to the information related to the input 66 to the first MLM 44-1 via the message bus 40. The communication can include the identified discrepancy between the recommendation in the first role specific output 66-1 and the existing compliance rules in the system security policies database 48 and a message that the proposed modification is invalid. Based on the communication received from the first MLM 70-1 via the message bus 40, the first MLM 44-1 of the first set of MLMs 44 updates the first specific role output 66-1 by accessing the system security policies database 48 and regenerating the first role specific output 66-1 to take into account the identified discrepancy in the communication from the first MLM 70-1. The first MLM 44-1 can thus produce a regenerated proposed modification to the unit of software instructions 23 to send to the first MLM 70-1. The first MLM 70-1 can perform an iterative verification process on the information related to the input 66 until discrepancies are no longer identified in the information related to the input 66.

In some implementations, the second set of MLMs 70 can perform conflict resolution to determine which information in the information related to the input 66 should be prioritized. The second set of MLMs 70 can include a second MLM 70-2 for conflict resolution. For example, the information related to the input 66 can include the first role specific output 66-1 and the second role specific output 66-2. The first role specific output 66-1 can be based on information generated by the first MLM 44-1 having the security role 58 and accessing the system security policies database 48. The first role specific output 66-1 further includes guidance and/or recommendations based on the input 20 related to ensuring the user 24 complies with the system security policies in the system security policies database 48. Likewise, the second role specific output 66-2 can be based on information generated by the second MLM 44-2 having the company policy role 60 and accessing the company policies database 50. The second role specific output 66-2 includes guidance and/or recommendations based on the input 20 related to ensuring the user 24 complies with company policies in the company policies database 60. The second MLM 70-2 can determine that the guidance and/or recommendations in the second role specific output 66-2 conflict with the guidance and/or recommendations in the second role specific output 66-1, such that the guidance and/or recommendations in the second role specific output 66-2, while being consistent with company policy, would violate system security policies as given in the first role specific output 66-1. For example, the second role specific output 66-2 can include proposed modifications to the unit of software instructions 23 that include general recommendations to retain user data for a predetermined number of years. However, the first role specific output 66-1 includes a proposed modification to the unit of software instructions 23 that includes data sanitization functions to be implemented in the unit of software instructions that sanitize user data after a number of years lower than the predetermined number of years in the second role specific output 66-2. The second MLM 70-2 can determine that that user 24 cannot adopt both proposed modifications without failing to comply with at least one set of policies.

In some implementations, the second MLM 70-2 can determine whether the first role specific output 66-1 or the second role specific output 66-2 should be used in further processing. Following the previous example, the second MLM 70-2 can determine that, because the first role specific output 66-1 provides proposed modifications based on system security policies, that the first role specific output 66-1 has a higher priority than the second role specific output 66-2 having company policy guidance and/or recommendations. As a result, the second MLM 70-2 can determine that the second role specific output 66-1 from the information related to the input 66 is invalid When the second MLM 70-2 determines the second role specific output 66-2 is invalid, the second role specific output 66-2 can be removed from the information related to the input 66 before sending the information related to the input out for further processing.

In some implementations, to determine the priority of role specific outputs, the second MLM 70-2 can determine a hierarchy for the role specific outputs based on the role of the associated MLM of the first set of MLMs 44 that generated the role specific output. In some implementations, the second MLM 70-2 is trained with tags associated with the roles in the role assignor 56, such that each role is given a level of precedence relative to other roles in the role assignor 56. For example, the security role 58 can have a higher precedence relative to the company policy role 60. Additionally or alternatively, the second MLM 70-2 can identify the unique identifiers in the role specific outputs to determine the associated MLM of the first set of MLMs 44 that generated a respective role specific output, and use that determination to identify the associated role of the MLM. Following the previous example, the second MLM 70-2 can identify the unique identifier in the first role specific output 66-1 as being associated with the first MLM 44-1 having the security role 58. The second MLM 70-2 can also identify the unique identifier in the second role specific output 66-2 as being associated with the second MLM 44-2 having the company policy role 60. Based on training data, the second MLM 70-2 can determine that the first role specific output 66-1 has precedence over the second role specific output 66-2 that is causing conflict, and therefore prioritize the first role specific output 66-1. In prioritizing the first role specific output 66-1, the second MLM 70-2 determines that the second role specific output 66-2 is invalid and retains the first role specific output 66-1.

In some implementations, the second set of MLMs 70 generates validated information 72 based on the evaluation processes performed on the information related to the input 66. In some implementations, where the second set of MLMs 70 finds no discrepancies or conflicts in the information related to the input 66, the validated information 72 is the same as the information related to the input 66. For example, if the information related to the output 66 includes the proposed modification to the unit of software instructions 23 in the security compliance output generated by the first MLM 44-1 contains no inaccuracies nor conflicts with any other role specific outputs, the validated information 72 is the same as the information related to the input 66, and the validated information 72, indicating that the second set of MLMs 70 validates that the proposed modification to the unit of software instructions 23 complies with the set of security compliance policies.

In some implementations, where the second set of MLMs 70 has found discrepancies and/or conflicts in the information related to the input 66, the validated information 72 can include the corrected information based on the verification performed by the first MLM 70-1 and/or the role specific output(s) retained by the second MLM 70-2. For example, if there was an inaccuracy in the proposed modification to the unit of software instructions 23, the first role specific output 66-1 can include the updated proposed modification to the unit of software instructions 23 and indicate that the second set of MLMs 70 validates that the proposed modification to the unit of software instructions 23 in the validated information 72 complies with the set of security compliance policies in the system security policies database 48.

In some implementations, the validated information 72 can indicate that one or more proposed modifications of the plurality of proposed modifications to the unit of software instructions comply with the set of security policies. Where one or more proposed modifications are validated in the validated information 72, only the one or more proposed modifications are sent for further processing by the computing system 12.

The memory includes an output obtainer 74. The output obtainer 74 can obtain an output for the input 20 based on the information related to the input 66 and/or the validated information 72 received by the first set of MLMs 44 and/or the second set of MLMs 70. The output obtainer can include a third set of MLMs 76 of the plurality of MLMs, including a first MLM 76-1, a second MLM 76-2, up to NTH MLM 76-N. There is no limit as to the number of MLMs that can be included in the third set of MLMs 76.

The third set of MLMs 76 can obtain an output in response to the input 20 received from the user 24. The third set of MLMs 76 receives the information related to the input 66 and/or the validated information 72 from the first set of MLMs 44 and/or the second set of MLMs 70 via the message bus 40. In some implementations, the third set of MLMs 76 receives all communications sent between the first set of MLMs 44 and the second set of MLMs 70 via the message bus 40. In some implementations, the first MLM 76-1 can analyze the information received from the first set of MLMs 44 and/or the second set of MLMs 70 to generate a plurality of candidate outputs, each including a candidate output type. For example, a candidate output type can be specific instructions for the user 24 to comply with the compliance rules information in the information related to the input 66. Alternatively, the candidate output type can be general recommendations for the user 24, such as examples of best practices rather than defined instructions. In some implementations, the output includes a modified unit of software instructions that incorporates the one or more proposed modifications identified in the validated information 72 as complying with the set of security compliance policies. From the plurality of candidate outputs and corresponding candidate output types, the third set of MLMs 76 can select an output 78 having a first output type 80 to send to the user 24. In some implementations, the third set of MLMs 76 sends the output 78 to the intermediary MLM 38 via the message bus 40. The intermediary MLM 38 then sends the output 78 to the user 24 via the network 26. In some implementations, the third set of MLMs 76 communicates directly with the user 24 to provide the output 78.

In some implementations, the first MLM 76-1 can generate simulations for the plurality of candidate outputs. The first MLM 76-1 simulates potential interactions with the user 24 based on each candidate output if the respective candidate output were provided to the user 24. For example, if a candidate output were provided related to company policies having a candidate output type of a modified unit of software instructions 23, the first MLM 76-1 can simulate how the user 24 would respond and/or react to the candidate output. Based on the simulations, the third set of MLMs 76 can select the output 78 from the plurality of candidate outputs.

For example, the first MLM 76-1 can receive the information related to the input 66 and/or the validated information 72 from the first set of MLMs 44 and/or the second set of MLMs 70. The information related to the input 66 and/or the validated information 72 can include information related to system security policies, company policies, laws, and product compliance policies. The first MLM 76-1 can simulate a plurality of interactions with the user 24 based on candidate outputs including any combination of the policies. For example, the simulated interactions can include a first candidate output including only system security policies, a second candidate output including system security policies and company policies, a third candidate output including all policies, and the like. As another example, the plurality of interactions can include a plurality of modified units of software instructions, each including a different combination of the one or more proposed modifications in the validated information 72, such that each of the plurality of interactions includes at least one of the one or more proposed modifications. There is no limit as to how many candidate outputs and simulations thereof may be generated by the first MLM 76-1.

The third set of MLMs 76 can generate an output 78. More specifically, the third set of MLMs 76 can process the validated information 72 and the information related to the input 66 to generate the output 78. In some implementations, the output 78 can include a modified unit of software instructions. The modified unit of software instructions can incorporate the one or more proposed modifications validated by the validated information 72. Alternatively, in some implementations, the third set of MLMs 76 can determine to generate a modified unit of software instructions that only incorporates some of the validated proposed modifications to the unit of software instructions 23.

As a specific example, assume that the first role specific output 66-1 describes a proposed modification to remove a recursive function from the unit of software instructions 23. Further assume that the second role specific output 66-2 describes a proposed modification to add a data verification function. The third set of MLMs 76 can process the first role specific output 66-1 and the second role-specific output 66-2 to generate the output 78 that includes the modified unit of software instructions. In some instances, the modified unit of software instructions may include one, or both, of the proposed modifications. In other instances, the third set of MLMs 76 may determine to forego one of the proposed modifications. For example, the MLM 76-2 may be assigned a testing role that performs unit tests of the proposed modifications, and forego inclusion of one of the proposed modifications based on the results of the testing.

In some implementations, to generate the output 78, the third set of MLMs 76 processes historical information alongside the information related to the input 66 and/or the validated information 72. The third set of MLMs 76 accesses a historical information database 82. The historical information database 82 can include prior outputs generated using the third set of MLMs 76. For example, the historical information database 82 can include a prior query 84 received from the user 24 in a previous interaction with the computing system 12. The historical information database further includes a corresponding prior output 86 generated by the third set of MLMs 76 in response to the prior query 84. The prior output 86 includes a corresponding prior output type 88, such as specific instructions or general recommendations. The historical information database 82 can include a plurality of prior queries and corresponding prior outputs 86 with corresponding output types.

In some implementations, the second MLM 76-2 is trained on the historical information accessed in the historical information database 82. Based on the training, the second MLM 76-2 can develop a profile for the user 24. The profile can include information related to the software being developed by the user 24 as well as predicted expectations of the user 24. For example, the second MLM 76-2 can predict that the user 24 is concerned primarily with system security in developing the software based on the prior query 84. Using the predicted expectations of the user 24, the second MLM 76-2 can determine which candidate output is to be selected to send to the user 24, such as proposed modifications to the unit of software instructions 23 based on the security compliance output in the first role specific output 66-1 generated by the first MLM 44-1.

In some implementations, the second MLM 76-2 receives the simulations of the plurality of candidate outputs from the first MLM 76-1 via the message bus 40. The second MLM 76-2 can then compare the simulated interactions generated by the first MLM 76-2 with the profile of the user 24, including the historical information in the historical information database 82. For example, the second MLM 76-2 can compare each of the simulated interactions of the candidate outputs against the prior query 84 and prior output 86 to determine which of the simulated interactions is most aligned with the historical information and the profile of the user 24. Based on the comparison, the second MLM 76-2 can select the output 78 from the candidate outputs. For example, if the second MLM 76-2 develops a profile based on the historical information database 82 that indicates the user is concerned with system security and company policy, the second MLM 76-2 can select the simulated interaction the output 78 having a first output type 80 of proposed modifications to the unit of software instructions 23 in order to comply with system security policies and company policies from the compliance rules database 46.

In some implementations, the plurality of MLMs, including the first set of MLMs 44, the second set of MLMs 70, and the third set of MLMs 76 are all hosted by the computing device 12. In some implementations, the plurality of MLMs can be separated onto multiple computing devices. For example, the first set of MLMs 44 can be hosted on a first computing device. The second set of MLMs 70 can be hosted on a second computing device. The third set of MLMs 76 can be hosted on a third computing device. The computing devices can communicate with one another via the network 26 and/or send and receive communications using the message bus 40. In some implementations, the computing environment 10 includes a first computing device hosting the first set of MLMs 44 and the second set of MLMs 70 and a second computing device hosting the third set of MLMs 76.

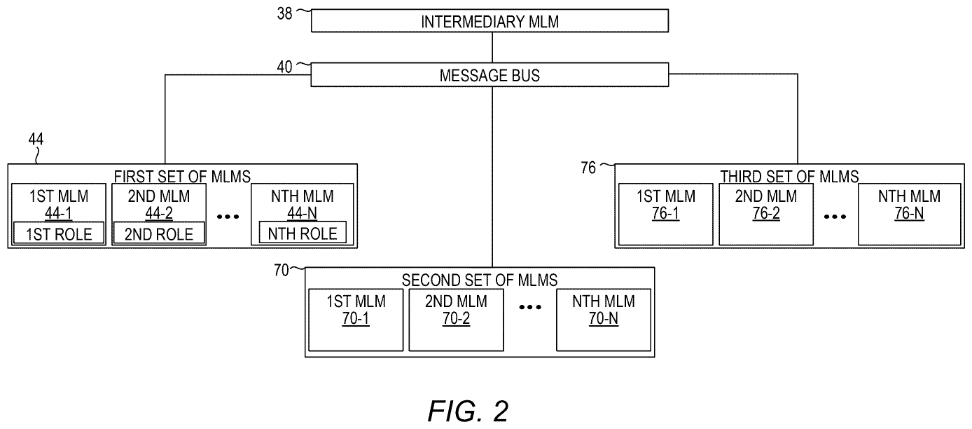

FIG. 2 is a block diagram of the plurality of machine-learned models for the machine-learned model based compliance system according to some implementations of the present disclosure. FIG. 2 provides an illustrative structure of communications between the intermediary MLM 38, first set of MLMs 44, second set of MLMs 70, and third set of MLMs 76 (collectively, the plurality of MLMs). The plurality of MLMs can engage in inter-model communication with one another via the message bus 40. When one MLM of the plurality of MLMs sends a communication via the message bus 40, each other MLM in the plurality of MLMs receives the communication simultaneously. For example, if the first set of MLMs 44 sends out the information related to the query 66, the intermediary MLM 38, the second set of MLMs 70, and the third set of MLMs 76 receive the information related to the query 66. The inter-model communication provides for the plurality of MLMs to process sets of information in context of all other information in the computing system 12.

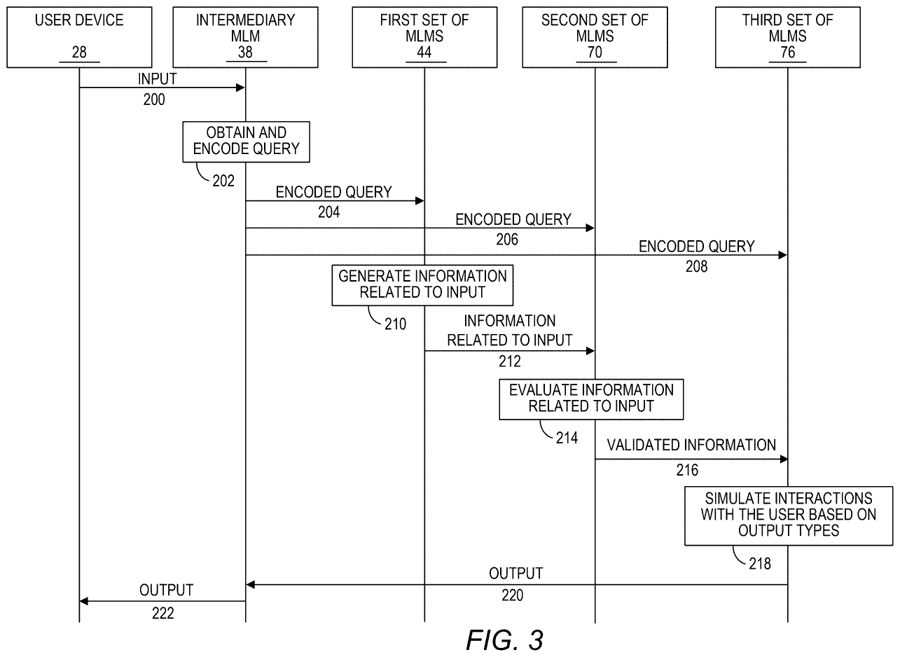

FIG. 3 is a sequence flow diagram for a machine-learned model based compliance system according to some implementations of the present disclosure. FIG. 3 will be discussed in conjunction with FIG. 1. More specifically, the intermediary MLM 38 receives the input 20 from the user device 28 to obtain the query 22. In some implementations, the query 22 includes natural language. The intermediary MLM 38 can encode the query 22 to obtain an encoded query. For example, the intermediary MLM 38 can perform one-hot encoding to the query 22 to convert the query into numerical values. For later processing by the plurality of MLMs. The intermediary MLM then sends the encoded query to the first set of MLMs 44, the second set of MLMs 70, and the third set of MLMs 76 via the message bus 40.

Once the first set of MLMs 44 receives the encoded query from the intermediary MLM 38, each MLM in the first set of MLMs 44 evaluates the set of compliance rules in the compliance rules database 46 to generate the information related to the input 66. The first set of MLMs 44 sends the information related to the input 66 to the second set of MLMs 70 via the message bus.

Once the second set of MLMs 70 receives the information related to the input 66, the second set of MLMs 70 processes the encoded query and the information related to the input 66 to validate the information related to the input 66, including using the first MLM 76-1 to verify the accuracy of the information in the information related to the input 66 and using the second MLM 76-2 to resolve any conflicts between the first role specific output 66-1 and the second role specific output 66-2 as described previously with respect to FIG. 1. After the information related to the input 66 has been validated by the second set of MLMs 70, the second set of MLMs 70 sends the validated information 72 to the third set of MLMs 76 via the message bus 40.

The third set of MLMs 76 can process the validated information 72 (i.e. the information related to the input 66) by comparing historical information to a plurality of candidate output types. The first MLM 76-1 generates a plurality of simulations based on the plurality of generated candidate outputs and corresponding outputs. The first MLM 76-1 sends the generated simulations to the second MLM 76-2 via the message bus 40. The second MLM 76-2 compares each of the generated simulations to the profile associated with the user 24 to determine which candidate output is most aligned with the predicted expectations of the user 24. The second MLM 76-2 selects the output 78 having the first output type 80 from the plurality of candidate types. Once selected, the third set of MLMs 76 sends the output 78 to the intermediary MLM 38 via the message bus 40. In some implementations, the output 78 is encoded, wherein the intermediary MLM 38 decodes the output 78 once received. The intermediary MLM 38 then sends the output 78 to the user 24 via the network 26.

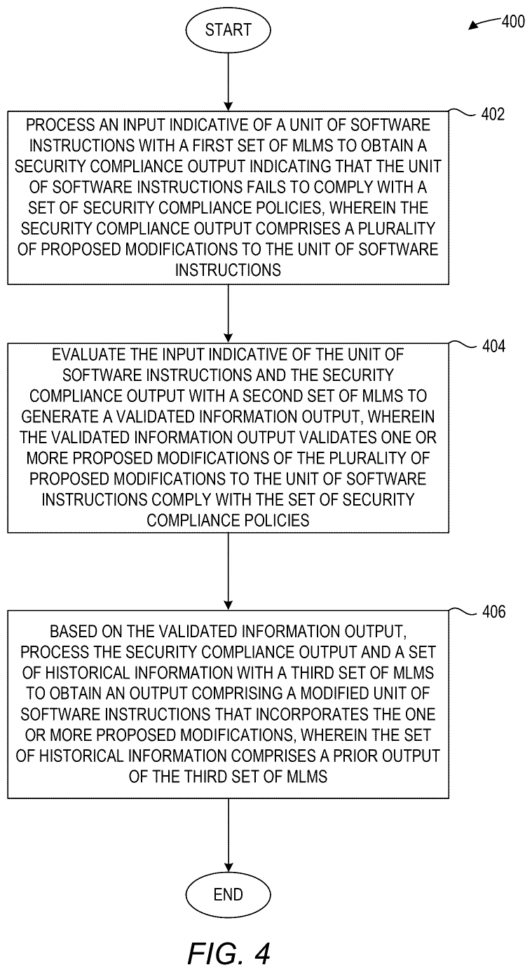

FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system can process an input indicative of a unit of software instructions using a first set of MLMs to obtain a security compliance output indicating that the unit of software instructions fails to comply with a set of security compliance policies. The security compliance output includes a plurality of proposed modifications to the unit of software instructions.

At 404, the computing system can evaluate the input indicative of software instructions and the security compliance output with a second set of MLMs to generate a validated information output. The validated information output validates one or more proposed modifications of the plurality of proposed modifications to the unit of software instructions comply with the set of security compliance policies.

At 406, the computing system can, based on the validated information output, process the security compliance output and a set of historical information with a third set of MLMs to obtain an output comprising a modified unit of software instructions that incorporates the one or more proposed modifications The set of historical information includes a prior output of the third set of MLMs.

In some implementations, the corresponding output of the historical information can include a corresponding output type.

In some implementations, processing the security compliance output can include comparing the one or more proposed modifications to the historical information with the third set of MLMs. Based on comparing the one or more proposed modifications to the historical information, the computing system can select the one or more proposed modifications to incorporate into the modified unit of software instructions. In some implementations, comparing the one or more proposed modifications to the historical information can include simulating an interaction with the user based on a candidate modification of the one or more proposed modifications.

In some implementations, processing the input indicative of the unit of software instructions with the first set of MLMs to obtain the security compliance output includes assigning a first role to a first MLM of the first set of MLMs. The first role includes a security role that accesses a system security policies database associated with the security role. Based on the first role, the first MLM of the first set of MLMs processes the input indicative of the unit of software instructions and one or more first data elements obtained from the system security policies database to obtain a first role-specific output. The first role can include a company policy role that accesses a company policies database, a legal role that accesses a legal database, a product compliance role that accesses a product compliance database, or a regulatory standards role governing access to a regulatory standard database. In some implementations, generating the information related to the input can further include assigning a second role from the set of roles to a second MLM of the first set of MLMs. The second role can be different from the first role and accesses a second database associated with the second role. Based on the second role, the second MLM of the first set of MLMs can process the input indicative of the unit of software instructions and one or more second data elements obtained from the second database to obtain a second role-specific output. In some implementations, the first role-specific output includes an information query for the second MLM of the first set of MLMs. The second-role specific output can include an associated response to the information query. The second MLM of the first set of MLMs can send the associated response to the first MLM of the first set of MLMs via the message bus.

In some implementations, evaluating the input indicative of the unit of instructions and the security compliance output can include processing the information related to the input using a first MLM of the second set of MLMs. The computing system can send a communication from the first MLM of the second set of MLMs to the first set of MLMs. Based on the communication received from the first MLM of the second set of MLMs, the computing system via the first set of MLMs can update the information related to the input. In some implementations, the communication can include a discrepancy between the information related to the input and the set of compliance rules. In some implementations, the first set of MLMs can update the security compliance output based on the communication. In some implementations, the second set of MLMs can determine that a first proposed modification of the plurality of proposed modifications to the unit of software instructions is invalid.

In some implementations, processing the input indicative of the unit of software instructions with the first set of MLMs can include generating a first role specific output using a first MLM of the first MLMs and a second role specific output using a second MLM of the first set of MLMs. Evaluating the input indicative of the unit of software instructions and the security compliance output with the second set of MLMs includes the computing system using a first MLM of the second set of MLMs determining whether the first role specific output or the second role specific output should be sent to the third set of MLMs for processing. In some implementations, the third set of MLMs can determine that the second role specific output is invalid, such that the first role specific output is sent to the third set of MLMs for further processing.

In some implementations, where the input indicative of the unit of software instructions includes a natural language query, processing the input can include encoding the natural language query to obtain an encoded query. The computing system can transmit the encoded query to the first set of MLMs, the second set of MLMs, and/or the third set of MLMs.

In some implementations, once the output has been obtained, the computing system can send the output to the user.

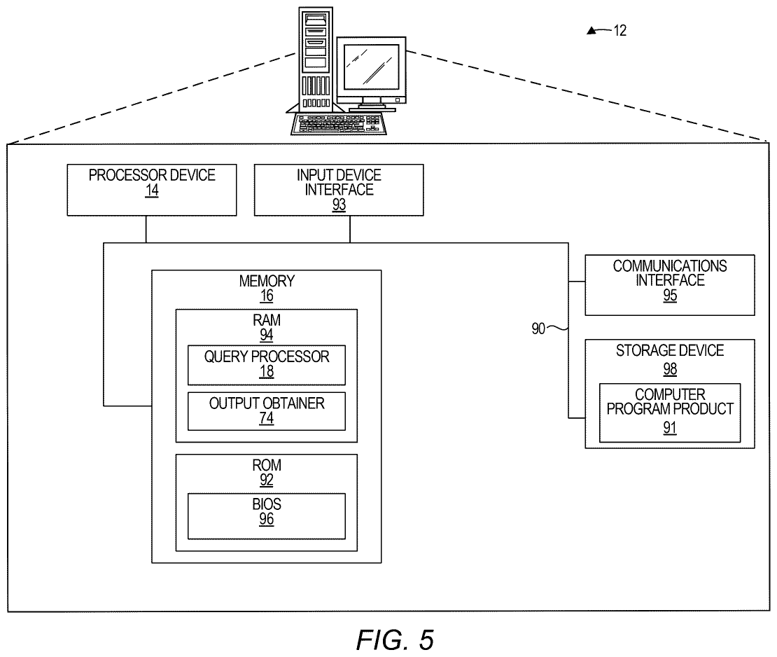

FIG. 5 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 12 includes the processor device(s) 14, the system memory 16, and a system bus 90. The system bus 90 provides an interface for system components including, but not limited to, the system memory 16 and the processor device(s) 14. The processor device(s) 14 can be any commercially available or proprietary processor.

The system bus 90 may be any of several types of bus structures that may further interconnect to a memory bus (with or without a memory controller), a peripheral bus, and/or a local bus using any of a variety of commercially available bus architectures. The system memory 16 may include non-volatile memory 92 (e.g., read-only memory (ROM), erasable programmable read-only memory (EPROM), electrically erasable programmable read-only memory (EEPROM), etc.), and volatile memory 94 (e.g., random-access memory (RAM)). A basic input/output system (BIOS) 96 may be stored in the non-volatile memory 92 and can include the basic routines that help to transfer information between elements within the computing device 12. The volatile memory 94 may also include a high-speed RAM, such as static RAM, for caching data.

The computing device 12 may further include or be coupled to a non-transitory computer-readable storage medium such as the storage device 98, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 98 and other drives associated with computer-readable media and computer-usable media may provide non-volatile storage of data, data structures, computer-executable instructions, and the like.

A number of modules can be stored in the storage device 98 and in the volatile memory 94, including an operating system and one or more program modules, such as the input processor 18 and output obtainer 74, which may implement the functionality described herein in whole or in part. All or a portion of the examples may be implemented as a computer program product 91 stored on a transitory or non-transitory computer-usable or computer-readable storage medium, such as the storage device 98, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the input processor 18 and the output obtainer 74 in the volatile memory 94, may serve as a controller, or control system, for the computing device 12 that is to implement the functionality described herein.

An operator, such as the user 24, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 93 that is coupled to the system bus 90 but can be connected by other interfaces such as a parallel port, an Institute of Electrical and Electronic Engineers (IEEE) 1394 serial port, a Universal Serial Bus (USB) port, an IR interface, and the like. The computing device 12 may also include the communications interface 95, such as an Ethernet transceiver and/or a Wi-Fi transceiver, or the like, suitable for communicating with the network 26 as appropriate or desired. The computing device 12 may also include a video port configured to interface with a display device (not illustrated), to provide information to the user 24.

Individuals will recognize improvements and modifications to the preferred examples of the disclosure. All such improvements and modifications are considered within the scope of the concepts disclosed herein and the claims that follow.

What is claimed is:

1. A method, comprising:
processing, by a computing system comprising one or more processor devices, an input indicative of a unit of software instructions with a first set of machine-learned models (MLMs) to obtain a security compliance output indicating that the unit of software instructions fails to comply with a set of security compliance policies, wherein the security compliance output comprises a plurality of proposed modifications to the unit of software instructions;
evaluating, by the computing system, the input indicative of the unit of software instructions and the security compliance output with a second set of MLMs to generate a validated information output, wherein the validated information output validates that one or more proposed modifications of the plurality of proposed modifications to the unit of software instructions comply with the set of security compliance policies; and
based on the validated information output, processing, by the computing system, the security compliance output and a set of historical information with a third set of MLMs to obtain an output comprising a modified unit of software instructions that incorporates the one or more proposed modifications, wherein the set of historical information comprises a prior output of the third set of MLMs.

2. The method of claim 1, wherein the first set of MLMs, the second set of MLMs, and the third set of MLMs are operable to perform inter-model communication between one another.

3. The method of claim 1, wherein processing the security compliance output and the set of historical information with the third set of MLMs comprises:
comparing, by the computing system with the third set of MLMs, the one or more proposed modifications to the set of historical information; and
based on comparing the one or more proposed modifications to the set of historical information, selecting, by the computing system with the third set of MLMs, the one or more proposed modifications to incorporate into the modified unit of software instructions.

4. The method of claim 3, wherein comparing the one or more proposed modifications to the set of historical information comprises simulating, by the computing system with the third set of MLMs, an interaction with a user associated with the input based on a candidate modification of the one or more proposed modifications.

5. The method of claim 1, wherein processing the input indicative of the unit of software instructions with the first set of MLMs to obtain the security compliance output comprises:
assigning, by the computing system, a first role of a set of roles to a first MLM of the first set of MLMs, wherein the first role comprises a security role that accesses a system security policies database associated with the security role; and
based on the first role, processing, by the computing system, the input indicative of the unit of software instructions and one or more first data elements obtained from the system security policies database using the first MLM to obtain a first role-specific output.

6. The method of claim 5, wherein the set of roles comprises:
a company policy role that accesses a company policies database;
a legal role that accesses a regulatory database; or
a product compliance role that accesses a product compliance database.

7. The method of claim 5, wherein processing the input indicative of the unit of software instructions further comprises:
assigning, by the computing system, a second role of the set of roles to a second MLM of the first set of MLMs, wherein the second role is different than the first role, and wherein the second role accesses a second database associated with the second role; and
based on the second role, processing, by the computing system, the input indicative of the unit of software instructions and one or more second data elements obtained from the second database using the second MLM to obtain a second role-specific output.

8. The method of claim 7, wherein:
the first role-specific output comprises an information query for the second MLM;
the second role-specific output comprises an associated response to the information query; and
wherein processing the input indicative of the unit of software instructions further comprises sending, by the computing system, the associated response from the second MLM to the first MLM via a message bus.

9. The method of claim 1, wherein evaluating the input indicative of the unit of software instructions and the security compliance output comprises:
processing, by the computing system, the security compliance output using a first MLM of the second set of MLMs; and
sending, by the computing system, a communication from the first MLM of the second set of MLMs to the first set of MLMs, wherein the communication is descriptive of a discrepancy between a first proposed modification of the one or more proposed modifications and the set of security compliance policies.

10. The method of claim 9, wherein evaluating the input indicative of the unit of software instructions and the security compliance output further comprises updating, by the computing system, the security compliance output with the first set of MLMs based on the communication.

11. The method of claim 9, wherein evaluating the input indicative of the unit of software instructions and the security compliance output further comprises determining, by the computing system with the second set of MLMs, that a second proposed modification of the plurality of proposed modifications to the unit of software instructions is invalid.

12. The method of claim 1, wherein processing the input indicative of the unit of software instructions with the first set of MLMs comprises:
generating, by the computing system, a first role specific output using a first MLM of the first set of MLMs; and
generating, by the computing system, a second role specific output using a second MLM of the first set of MLMs; and
wherein evaluating the input indicative of the unit of software instructions and the security compliance output with the second set of MLMs comprises determining, by the computing system using a third MLM of the second set of MLMs, whether the first role specific output or the second role specific output should be sent to the third set of MLMs for processing.

13. The method of claim 12, wherein determining whether the first role specific output or the second role specific output should be sent to the third set of MLMs comprises determining, by the computing system, that the second role specific output is invalid.

14. The method of claim 1, wherein the input indicative of the unit of software instructions comprises a natural language query, and wherein processing the input further comprises:
encoding, by the computing system, the natural language query to obtain an encoded query; and
transmitting, by the computing system, the encoded query.

15. The method of claim 1, further comprising sending, by the computing system, the output to a user.

16. A computing system comprising:
a processor; and
one or more non-transitory, computer-readable media that store instructions that, when executed by the processor, cause the computing system to:
process an input indicative of a unit of software instructions with a first set of machine-learned models (MLMs) to obtain a security compliance output indicating that the unit of software instructions fails to comply with a set of security compliance policies, wherein the security compliance output comprises a plurality of proposed modifications to the unit of software instructions;
evaluate the input indicative of the unit of software instructions and the security compliance output with a second set of MLMs to generate a validated information output, wherein the validated information output validates that one or more proposed modifications of the plurality of proposed modifications to the unit of software instructions comply with the set of security compliance policies; and
based on the validated information output, process the security compliance output and a set of historical information with a third set of MLMs to obtain an output comprising a modified unit of software instructions that incorporates the one or more proposed modifications, wherein the set of historical information comprises a prior output of the third set of MLMs.

17. The computing system of claim 16, wherein, to process the security compliance output and the set of historical information with the third set of MLMs, the instructions further cause the computing system to:
compare, with the third set of MLMs, the one or more proposed modifications to the set of historical information; and
based on comparing the one or more proposed modifications to the set of historical information, select, with the third set of MLMs, the one or more proposed modifications to incorporate into the modified unit of software instructions.

18. The computing system of claim 16, wherein, to compare the plurality of candidate output types to the historical information, the instructions further cause the computing system to simulate an interaction with a user associated with the input based on a candidate modification of the one or more proposed modifications.

19. The computing system of claim 16, wherein, to process the input indicative of the unit of software instructions with the first set of MLMs to obtain the security compliance output, the instructions further cause the computing system to:
assign a first role of a set of roles to a first MLM of the first set of MLMs, wherein the first role comprises a security role that accesses a system security policies database associated with the security role; and
based on the first role, process, the input indicative of the unit of software instructions and one or more first data elements obtained from the system security policies database using the first MLM to obtain a first role-specific output.

20. One or more non-transitory computer-readable storage media that store instructions that, when executed by a processor of a computing system, cause the processor to:
process an input indicative of a unit of software instructions with a first set of machine-learned models (MLMs) to obtain a security compliance output indicating that the unit of software instructions fails to comply with a set of security compliance policies, wherein the security compliance output comprises a plurality of proposed modifications to the unit of software instructions;
evaluate the input indicative of the unit of software instructions and the security compliance output with a second set of MLMs to generate a validated information output, wherein the validated information output validates that one or more proposed modifications of the plurality of proposed modifications to the unit of software instructions comply with the set of security compliance policies; and
based on the validated information output, process the security compliance output and a set of historical information with a third set of MLMs to obtain an output comprising a modified unit of software instructions that incorporates the one or more proposed modifications, wherein the set of historical information comprises a prior output of the third set of MLMs.
